(19) United States
(12) Patent Application Publication
(10) Pub. No.: US 2009/0265186 A1
(43) Pub. Date: Oct. 22, 2009

(54) System and Method for Communicating Environmentally-Based Medical Advice

(75) Inventors: Lionel Tarassenko, Oxford (GB); William Ross Cobern, London (GB); Patrick Eugene McSharry, Oxford (GB)

Correspondence Address: NIXON & VANDERHYE, PC, 901 NORTH GLEBE ROAD, 11TH FLOOR, ARLINGTON, VA, 22203, US

(73) Assignee: E-SAN LIMITED, Oxford (GB)

(21) Appl. No.: 12/084,952

(22) PCT Filed: Nov. 10, 2006
(86) PCT No.: PCT/GB2006/004217

§ 371 Date: Jun. 26, 2009

(30) Foreign Application Priority Data
Nov. 17, 2005 (GB) 0523447.1

(51) Int. Cl. G06Q 50/00

(52) U.S. Cl. 705/3; 705/2

(57) ABSTRACT

A method and system for delivering advice to patients suffering from respiratory conditions based on changes in environment, such as weather or air quality changes. This system includes a patient specific model which uses input environmental data to predict changes in the patient's condition. The model is developed from an analysis of patient's responses to a variety of environmental triggers, and can be refined with time. The model can include only those specific triggers appropriate to a patient, can include the delay between the change in environment and change in condition of the patient, and can be run with data which is geographically localized to the patient's location. Conveniently the models can be run on personal devices held by the patients, such as mobile telephones, which are in communication with a server and/or a provider of environmental data.

The present invention relates to a system and method for communicating environmentally-based medical advice, in particular for improving the self-management of their condition by patients suffering from respiratory problems.

It is well-known that respiratory conditions such as asthma or chronic obstructive pulmonary disease (COPD) are significantly affected by environmental conditions such as the weather, air pollution, pollen count, etc. It has become common, therefore, to find forecasts of air quality being made available in the public media. Although this may be useful to some patients, in practice there is a great variation amongst patients as to the specific environmental conditions which trigger changes in their respiratory condition. For example, some people are badly affected by rises in temperature or humidity, whereas others are affected more by air quality, such as pollution or pollen count. Even within those groups the variations in specific trigger are large. Some people are affected by certain types of pollen but not others and some are affected by certain types of air pollution and not others. Consequently although the general form of air quality advice given in a weather forecast is of some use, it does not assist patients particularly well by enabling them to take the appropriate action for them.

It is also known that the health of patients is significantly improved if they can be empowered to manage the long-term condition themselves. Effective self-management not only results in direct improvement in their specific respiratory condition, but also improves their morale which is recognized as an important factor in generally improving the health of people suffering from long-term conditions.

The present applicants have made available a system as disclosed in WO 2004/027676 which allows patients with respiratory conditions to measure their health effectively with a mobile telephone based system in which a measuring device such as an electronic flow meter for measuring peak expired flow (PEF) and/or forced expired volume (FEV) is connected to the mobile telephone and readings are automatically stored on the telephone and submitted to a secure remote data server. Software on the telephone and/or server analyses the data and displays immediately to the patient an indication of their current state of health. An important feature is that the analysis is personal to the patient, so the display to the patient can indicate whether the patient's readings are good or bad for them, rather than whether they are good or bad on a global scale. This system has been found significantly to improve self-management and patients have appreciated the immediate feedback and the interest and empowerment in managing their condition.

The present invention provides a further improvement in self-management by encouraging a patient to take action to manage their condition (for example to change their medication) based on predictions of their future condition. These predictions are based on the patient's own known response to environmental factors. The personalization of the advice is important in view of the large variation between patients in response to various potential triggers.

Thus in more detail the present invention provides a communications system for providing support to patients suffering from respiratory conditions, the system comprising:
a plurality of patient-based data storage, processing and communications devices,
a server having a data store storing patient data, a processor for receiving, processing and outputting data and a communications interface in communication with the plurality of patient-based data storage, processing and communications devices and with a provider of environmental data,
the system further storing a predictive model for each patient for predicting changes in their respiratory condition from said environmental data,
and the system being adapted to retrieve regularly said environmental data from said provider, to run said predictive model with said retrieved environmental data, and to cause said patient-based data storage, processing and communications devices to display advice to the patient based on predicted changes in their respiratory condition.

In another aspect the invention provides a method of providing support advice to patients suffering from respiratory conditions, comprising:
providing a server having a data store storing patient data, a processor for receiving, processing and outputting data and a communications interface in communication with a plurality of patient-based data storage, processing and communications devices and with a provider of environmental data,
storing a predictive model for each patient for predicting changes in their respiratory condition from said environmental data,
and retrieving regularly said environmental data from said provider, to run said predictive model with said retrieved environmental data, and to cause said patient-based data storage, processing and communications devices to display advice to the patient based on predicted changes in their respiratory condition.

The predictive model can include the temporal dependence of the patient's respiratory conditions on each of a plurality of different environmental conditions. For example, it is found that for some patients their condition depends on the temperature or humidity that day, but for some patients other environmental triggers only affect their condition after a certain delay. For instance, response to an increase in pollution levels may be delayed by a few days. Including this temporal dependence of the response in the predictive model allows the patient to receive an accurate prediction of their condition over the next few days, and this may allow them to change their medication accordingly. This can therefore improve their self-management.

The predictive model may be run with environmental data which is geographically localized to the location of the patient. This may be the home address of the patient for patients who are at home or relatively immobile, or the geographical localization may occur automatically based on location data automatically provided from the patient-based data storage, processing and communications devices. For example where these devices are mobile telephones, the location of a mobile telephone is known because of the cellular nature of the network. Consequentially the environmental data provided to the predictive model is data selected to be appropriate for that geographical location.

The predictive model can be based on the responses of the respiratory conditions of a plurality of patients, i.e. can be a global or general model. More preferably, though, the model is specific to a group of patients whose responses are similar, or to a specific patient.

This can be achieved by making the model adaptive so that it changes with time to improve the agreement between its predictions and the subsequent measurements of the patient's condition. This allows patients to start initially with a general or global model, and then the model adapts gradually to the patient's own responses.

Alternatively updated models may be prepared on the server and, optionally after checking and validation by clinicians, be delivered wirelessly to the patient-based devices to replace the existing models.

The predictive model preferably models the response of the patient to a variety of environmental conditions including weather and air quality. Examples are temperature, pressure, humidity, rainfall, particulate or gas pollution levels, pollen count and so on. Two predictive models may be included for each patient representing the patient's condition at different times of day. It is found, for example, that a patient's condition during the day may be more affected by certain factors than their condition during the evening or night. This again allows better personalization of the advice to the patient.

Preferably the invention is used in conjunction with a system allowing the patient to measure their own condition effectively as disclosed in WO 2004/027676. This allows the patient to connect a measuring device to the patient-based data storage processing and communications device and for the readings to be stored and processed both locally and on the remote server. Storing the measurements is useful in allowing the model to be updated to improve agreement between its predictions and the patient's condition.

The predictive model may be stored and run on either or both of the patient-based data storage, processing and communications devices and the server.

The patient-based data storage, processing and communications devices may be a mobile telephone having data storage and processing capability, a personal computer with an internet connection, or even a digital television signal processor of the type which includes data storage and processing functionality. Thus the advice may be delivered to the patient by a variety of convenient routes.

The invention will be further described by way of example with reference to the accompanying drawings in which:—

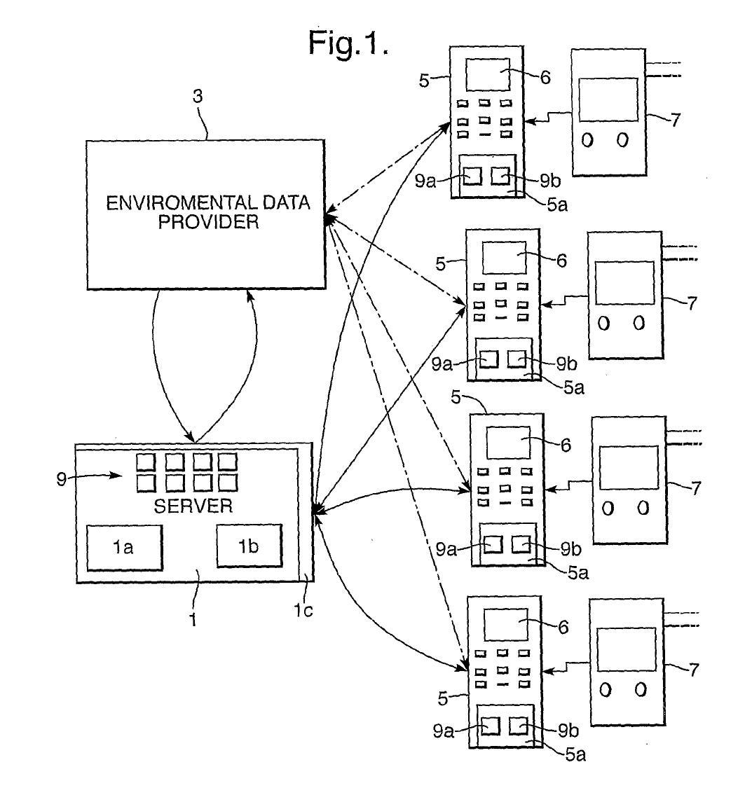

FIG. 1 schematically illustrates a system according to an embodiment of the invention;

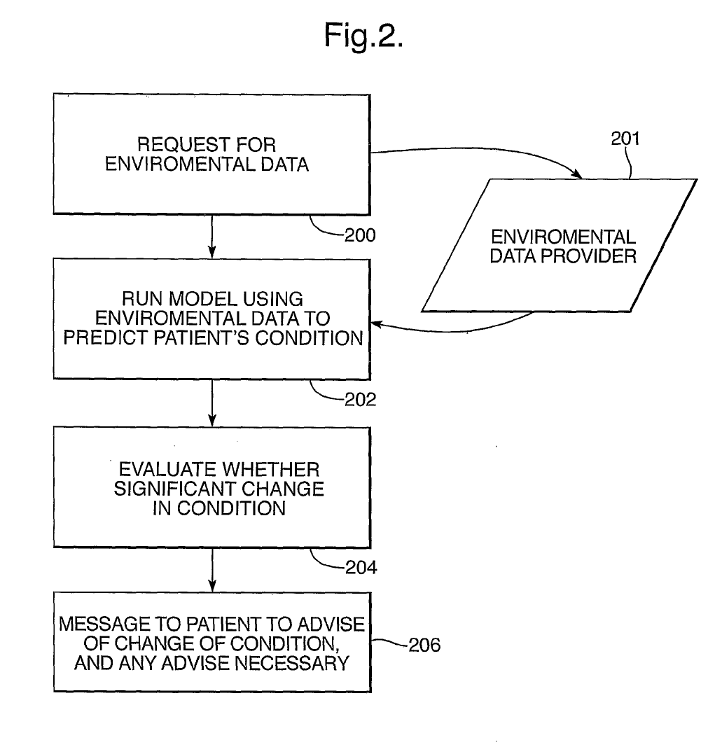

FIG. 2 is a flow diagram showing the operation of the embodiment of FIG. 1;

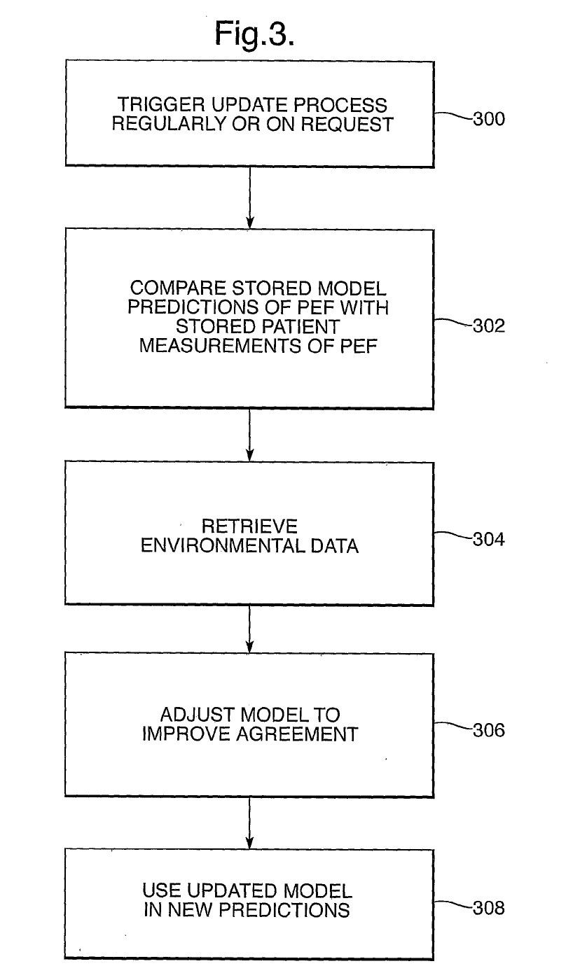

FIG. 3 is a flow diagram schematically illustrating how the predictive model is updated in the embodiment of FIG. 1;

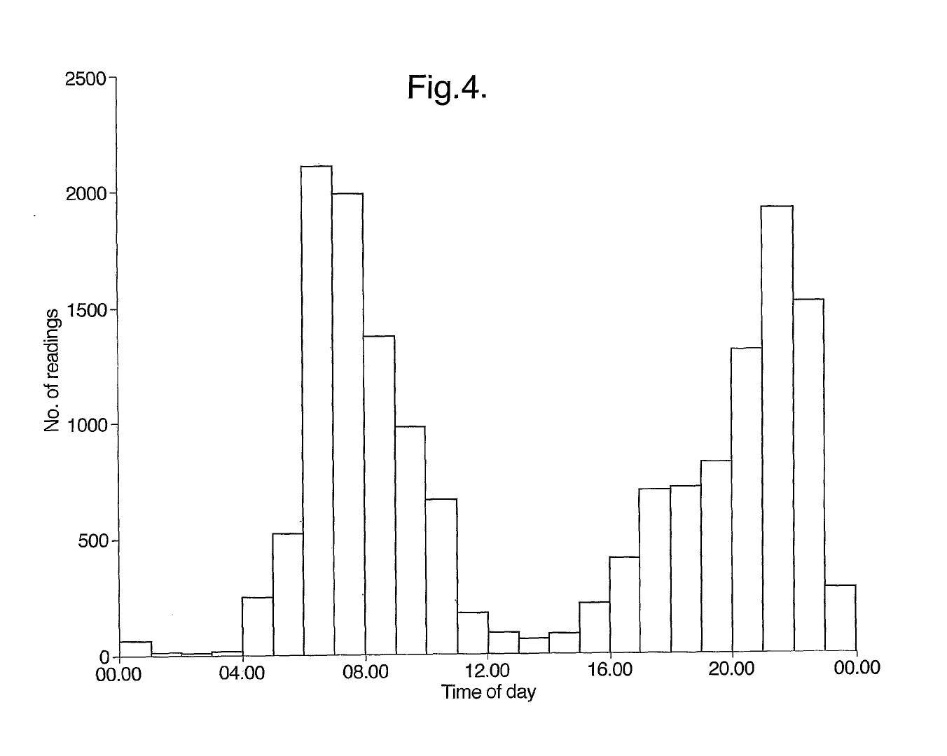

FIG. 4 is a histogram illustrating the time at which patients typically measure their condition;

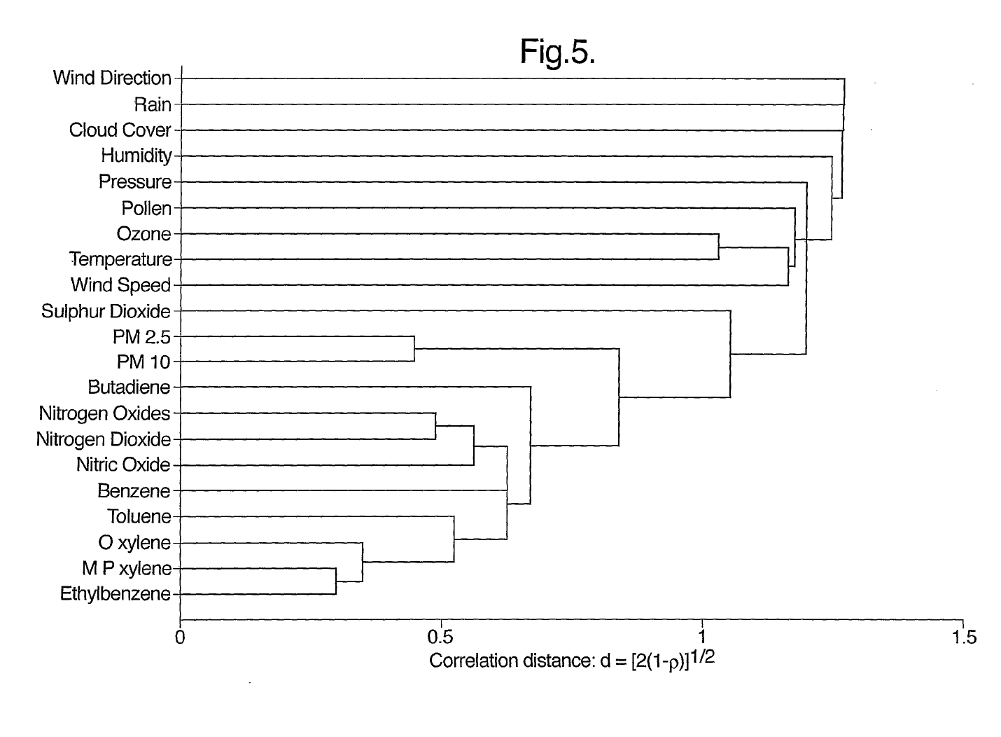

FIG. 5 is a correlation plot showing how various environmental conditions are correlated to each other;

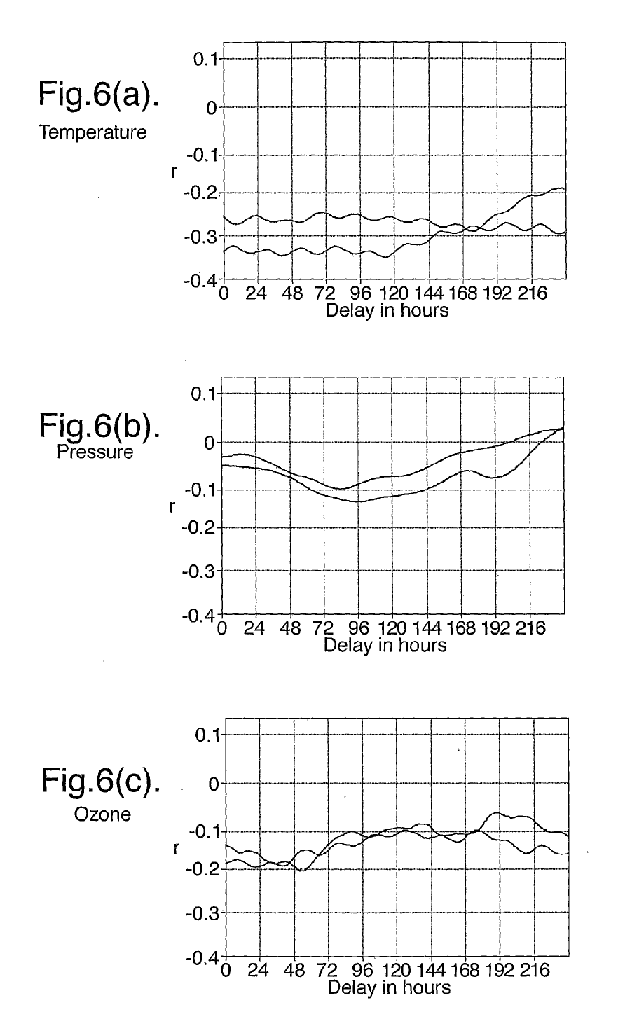

FIG. 6(a), (b) and (c) illustrate how three environmental factors, temperature, pressure and ozone respectively affect the respiratory condition of a typical asthma patient.

FIG. 1 schematically illustrates an embodiment of the invention. The system includes a server 1 which, as is conventional, includes a data processor 1a, a data store 1b, a communications interface 1c. It also stores a plurality of predictive models 9 of the patient's condition. These may be stored separately as illustrated, or in the data store 1b. The server is in communication with a plurality of patient-based data storage, processing and communications devices 5 (only four are illustrated but in practice there are many more, one for each patient) and in the present embodiment these are mobile telephones which include a data store and processor 5a. It will be appreciated that in other embodiments the devices could be PDAs, palmtop or laptop computers provided with communications functionality. Alternatively, the devices do not need to be mobile, but could be personal computers with an internet connection or digital television signal processors, such as set top boxes or integrated processors. As illustrated each of the patient-based data storage, processing and communications devices are connectable to an electronic flow meter 7 and this is used in accordance with the system disclosed in WO 2004/027676, incorporated herein by reference, allowing the patients to measure their respiratory condition and deliver the measurements via the devices 5 to the server 1.

As illustrated, the server 1 is also in communication with an environmental data provider 3, for example a weather data service.

Each of the devices 5 stores predictive models 9a and 9b which can predict the patient's respiratory condition for example for the next few days, when provided with environmental data. As illustrated each patient has two models, one, 9a for the patient's condition in the morning and one, 9b for the patient's condition in the evening. In an alternative embodiment these may be combined into a single model per patient. The models 9a and 9b are preferably specific to the patient and this may be achieved by starting with a general model and updating it as will be described later.

FIG. 1 also illustrates that the patient models are stored in addition on the server 1, though the models need not be stored in both places.

FIG. 2 illustrates the general operation of the system in use. At regular intervals environmental data is delivered in step 201 from the environmental data provider 3 to the server 1. As illustrated in step 200 of FIG. 2, the delivery is upon request by the server. The request may be regular, for example daily. The predictive models 9 are then run using the environmental data as indicated in step 202 in order to predict each patient's respiratory condition over the next few days. The system then evaluates whether there is a significant change in the patient's condition, in step 204 and then if there is displays a message to the patient to advise them of that fact and, optionally, to indicate to them what action they should take as indicated in step 206. For example, the system may be pre-programmed with advice on how to change the medication in the event of certain predicted changes in the respiratory condition. This can be particularly advantageous in the case of environmental triggers which cause a worsening in the patient's condition after a certain delay, of say two or three days. Certain medications take time to improve the patient's condition, and so providing advice on medication changes in advance of the predicted change can result in the effect of the medication temporally matching the effect of the environmental trigger. As a result it can reduce the amount of medication required and it can also reduce the need for emergency treatment.

FIG. 1 illustrates the models 9 being stored and run on the server 1 and the server 1 requesting and receiving the environmental data from the environmental data provider 3. However, as shown by dotted lines it is possible for the patient-based devices 5 to request environmental data directly from the provider 3, in which case the models 9a and 9b on the devices 5 can run using that data.

In this embodiment of the invention the environmental data provided can be confined to only those triggers appropriate to each patient, and can be geographically localized having regard to the location of the patient. Thus only weather or air quality data appropriate to the location of a particular patient need be delivered, or only the particular environmental triggers appropriate to that patient (for example temperature and pollution) need be delivered. This is achievable with the present invention because the model can be personalized to the patient so that it only includes those triggers appropriate to that patient.

The location of the patient may be known from their home address, or in the case of mobile communications with the devices 5, can be automatically retrieved. For example, when using cellular communications technology, the communications system knows in which cell the device 5 is located and the environmental data which is geographically localized to that cell can be delivered.

FIG. 3 schematically illustrates the updating of the predictive models 9. As indicated at step 300, regularly, or on request, the update process is triggered. In step 302 the stored model predictions are compared with the stored patient measurements and in step 304 environmental data appropriate for the period of stored measurements and predictions are retrieved (these may be stored locally or retrieved from the server 1 or from the provider 3). The model may then be adjusted to improve the agreement between the predictions and measurements in the light of the retrieved environmental data. The optimization of models is well known and an optimization process appropriate for the particular model chosen will be used. The updated model is then used for subsequent predictions as indicated in step 308.

In one embodiment the models 9a and 9b on the devices 5 are adaptive and can update themselves. More preferably, though, the updated models are prepared at the server 1 and then delivered to the devices 5 over the wireless communications link. This allows for validation and checking of the updated models by clinicians before they are used. The delivery may occur automatically and periodically, or under the intervention and control of a clinician.

Explanation will now be given with reference to FIGS. 4 to 6 on how a predictive model 9 can be constructed.

A model can be constructed given a training set of data consisting of measurements of the patient's respiratory condition and environmental conditions taken over a training period. In the present embodiment the particular aspect of the patient's condition which is measured and monitored is the peak expired flow (PEF). Alternatively, it could be the forced expired volume (FEV) or other indicators of lung function. The model used in the embodiment of FIGS. 1 to 3 was developed from a set of several thousand PEF readings taken by a group of patients based in the south central area of the United Kingdom. The measurements were actually taken and delivered by the system described in WO 2004/027676. To construct the model environmental data including weather and air quality was also gathered from an environmental data provider for the period over which the readings were taken for that particular area of the United Kingdom. Firstly the readings were divided into two groups depending on when they were taken. As illustrated in FIG. 4 most readings are taken in the morning, at around 7.00 a.m. and in the evening at around 10.00 p.m. Therefore the readings were labelled as being morning readings if they occurred between 2.00 a.m. and 2.00 p.m. and evening readings if they occurred between 2.00 p.m. and 2.00 a.m. The reason for this is that it is found that the patient's condition in the morning and the evening can be affected by different environmental factors.

The individual PEF readings were then processed to produce a global data set which could be compared to the environmental triggers. The problem is that environmental triggers are a second order effect on the PEF readings, being much less relevant than, for example, medication usage by the individual patient. Consequently analysis of individual patient's readings is masked to a large extent by other contributory factors. Further, there are larger variations from patient to patient in what is normal, good or bad for that patient. Consequently the same PEF reading for two different patients can mean quite different things. Thus a measurement of respiratory condition is used which is based on a percentage of personal best peak flow.

To produce this percentage based measurement, first, outliers are removed from the training data sets (i.e. data acquired during a training period which can vary from a few weeks to a few months). Outliers are defined as PEF readings of less than 50 litres per minute and greater than the mean plus three standard deviations (of the PEF values for that patient over the whole of the training period). This removes readings which are anomalous because of poor technique. Then the percentage adjusted personal best (PEF′) is computed by dividing each PEF value by the reference PEF and multiplying by 100. The reference PEF is typically the mean of the largest five PEF values from the training period after removal of outliers.

$${PEF}^{′} = \frac{PEF}{Reference PEF} \times 100 \%$$

This is then corrected in a known way to remove the predictable effects of ageing and growth. For example, models have been published which indicate how the PEF varies with age and size, and these can be used to correct the PEF′ value. The resulting PEF′values are globally meaningful, meaning that values from different patients can be compared.

Having obtained PEF′ values which can be compared from patient to patient, a variety of environmental factors can then be chosen so that their correlation with the patient's condition can be analysed.

FIG. 5 is a dendrogram which lists on the vertical axis the various environmental factors considered and indicates on the horizontal axis how strongly they are correlated with each other. For example, it can be seen that the level of pollutants of various types listed towards the bottom of the vertical axis are relatively strongly correlated with each other, showing that when pollution by one pollutant is bad, it tends also to be bad for other pollutants. By considering the groupings of factors one factor can be taken as representative of several. This avoids having to develop a model with too many parameters.

For the purposes of this explanation, the atmospheric temperature, pressure and the ozone level will be considered. FIGS. 6(a), (b) and (c) illustrate cross-correlations of these three variables with the PEF′ for mornings and evenings. In these plots variables are significant at the 5% level if they lie outside of the grey area on the plot. It can be seen that the temperature as illustrated in FIG. 6a is more significant than the pressure or ozone level for this group of patients during this training period (nine months, in this case). Furthermore, it can be seen that the ozone level, for example, has an increasing effect up to 48 hours later. The atmospheric pressure similarly has a delayed effect, but no such delay is seen in temperature. Similar analysis can be done for the other environmental triggers to determine which triggers are significant for the patient or patients whose readings have been analysed during the training period and with what time delay. The table below indicates a group of environmental triggers or variables which were found to be significant together with the delay in days for the patients based on a south central area of the United Kingdom. Where two figures are given for the delay, both values of delay have been found to be relevant for either the evening reading (first value) or the morning reading (second value)

| Variable | Delay/days |
|---|---|
| Temperature | 0 |
| Humidity | 0, 3 |
| Pressure | 3.5, 4 |
| Nitric Oxide | 3 |
| Ozone | 0, 2 |
| PM₁₀ | 1, 3 |
| Benzene | 3 |
| Pollen | 0 |

A model is then constructed which explains the PEF′ in terms of the selected explanatory variables. This may be a linear model such as:

PEF′=a^{τ}x+b

In this model x is a vector of the selected variables with a variable delay for each taken from the table above. For example:—

x=x₁(t−τ₁), x₂(t−τ₂), . . . xₙ(t−τₙ)

It should be noted that different models are obtained for the morning and evening readings using the differently labelled groups of readings as mentioned above.

A simple two-variable model could take the following form:—

PEF′=a₀+a₁x₁(t−τ₁)+a₂x₂(t−τ₂)

where: a₀=153.03 a₁=−0.2458 a₂=−0.0678
x₁=temperature, τ₁=0
x₂=pressure, τ₂=3 days

In practice, though, more variables are usually included in the model.

Although the above simple model is linear, non-linear models such as neural networks can be used as well.

Developing the above model from readings for a large group of patients forms a general or global model. This model can be used initially in the system of FIGS. 1 to 3 though for best results the model should be personalized to the patient or to a group of patients of similar respiratory condition (for example, mild-to-moderate asthma) and age. This can be achieved by constructing the model using only readings for that patient or that group. Alternatively, where such readings are not available (for example because the patient is a new patient), the system can start off with the general model and then the model can be gradually refined and updated to personalize it to that patient as in FIG. 3.

1. A communications system for providing support to patients suffering from respiratory conditions, the system comprising:
a plurality of patient-based data storage, processing and communications devices,
a server having a data store storing patient data, a processor for receiving, processing and outputting data and a communications interface in communication with the plurality of patient-based data storage, processing and communications devices and with a provider of environmental data,
the system further storing a predictive model for each patient for predicting changes in their respiratory condition from said environmental data,
and the system being adapted to retrieve regularly said environmental data from said provider, to run said predictive model with said retrieved environmental data, and to cause said patient-based data storage, processing and communications devices to display advice to the patient based on predicted changes in their respiratory condition.

2. A communications system according to claim 1 wherein the predictive model includes the temporal dependence of the patients' respiratory conditions on each of a plurality of different environmental conditions.

3. A communications system according to claim 1 wherein the predictive model is run with data which is geographically localized to the location of the patient.

4. A communications system according to claim 3 wherein said geographical localization occurs automatically based on location data automatically provided from the patient-based data storage, processing and communications devices.

5. communications system according to claim 1 wherein the predictive model is based on the responses of the respiratory conditions of a plurality of patients to changes in environment.

6. A communications system according to claim 5 wherein the predictive model is based on the responses of the respiratory conditions of a selected group of similar patients to changes in environment.

7. A communications system according to claim 1 wherein the predictive model is specific to each patient.

8. A communications system according to claim 1 wherein the predictive model models the patient's response to a plurality of environmental conditions including weather and air quality.

9. A communications system according to claim 1 comprising two of said predictive models representing the patient's respiratory condition at different times of day.

10. A communications system according to claim 1 wherein the patient-based data storage, processing and communications devices are in communication with respective devices for measuring the patient's respiratory condition, the measurements being automatically stored on said patient-based data storage, processing and communications devices and communicated to said server.

11. A communications system according to claim 1 wherein the predictive model is stored and run on the patient-based data storage, processing and communications devices.

12. A communications system according to claim 1 wherein the predictive model is stored and run on the server.

13. A communications system according to claim 1 wherein the predictive model is an adaptive predictive model, and the system is adapted to update the model by storing predictions made by the predictive model, comparing the stored predictions to stored measurements of the patient's respiratory condition, and adjusting parameters of the predictive model to improve agreement between the stored predictions and measurements.

14. A communications system according to claim 13 wherein the predictive model for each patient starts as a general model and the system is adapted to change it over time by the update process to be specific to each patient.

15. A communications system according to claim 1 wherein the server is adapted to update the predictive model by storing predictions made by the predictive model, comparing the stored predictions to stored measurements of the patient's respiratory condition, and adjusting parameters of the predictive model to improve agreement between the stored predictions and measurements, and to deliver the updated model to the patient-based data storage, processing and communications devices, which store and run the updated predictive model

16. A communications system according to claim 1 wherein the patient-based data storage, processing and communications devices is a mobile telephone.

17. A communications system according to claim 1 wherein the patient-based data storage, processing and communications devices is a personal computer having an internet connection.

18. A communications system according to claim 1 wherein the patient-based data storage, processing and communications devices is a digital television signal processor.

19. A method of providing support advice to patients suffering from respiratory conditions, comprising:
providing a server having a data store storing patient data, a processor for receiving, processing and outputting data and an communications interface in communication with a plurality of patient-based data storage, processing and communications devices and with a provider of environmental data,
storing a predictive model for each patient for predicting changes in their respiratory condition from said environmental data,
and retrieving regularly said environmental data from said provider, to run said predictive model with said retrieved environmental data, and to cause said patient-based data storage, processing and communications devices to display advice to the patient based on predicted changes in their respiratory condition.
